(19) United States
(12) Patent Application Publication
(10) Pub. No.: US 2026/0348494 A1
(43) Pub. Date: Nov. 5, 2026

(54) CLAW FOR SECURING A VALVE ASSEMBLY

(71) Applicant: SNF INC, RICEBORO, GA (US)

(72) Inventors: Colin NICHOLSON, RICEBORO, GA (US); Paul FIELDS, RICEBORO, GA (US); Stacy HAMLIN, RICEBORO, GA (US); Johann KIEFFER, ANDREZIEUX-BOUTHEON (FR)

(21) Appl. No.: 19/198,661

(22) Filed: May 5, 2025

(51) Int. Cl. F16L 19/00

(52) U.S. Cl. CPC F16L 19/005

(57) ABSTRACT

A claw for securely immobilizing two compression nuts of a valve assembly. The valve assembly has one compression nut at each of its ends. The compression nuts each have a male spline located on an outer surface, and a stem and a bonnet. The bonnet has a plate extending in a plane substantially perpendicular to the stem. The claw has a first part and a second part, and releasable fastening means for securing the first part to the second part, the first part and said second part each having an inner surface with a female spline adapted to match the male spline of the outer surface of one of the compression nuts. The claw further has a through hole, configured so that when the first part and the second part are fastened to each other by the releasable fastening means. The through hole is configured to accommodate the plate of the bonnet. A valve unit has a valve assembly and the claw. A method is provided for securely immobilizing two compression nuts of the valve assembly, utilizing the claw. The claw is particularly useful to efficiently secure a valve assembly, the claw being easy to make and simple to use.

### TECHNOLOGICAL FIELD

The present invention relates to a claw for securely immobilizing two compression nuts of a valve assembly. The present invention also refers to a method for securely immobilizing two compression nuts of a valve assembly, wherein the claw is used. The claw is particularly useful to avoid movement of the compression nuts of a valve assembly over time, especially when the valve assembly is subject to vibrations.

### BACKGROUND

Valves assemblies are commonly placed between two fluid conduits, such as pipes. Valve assemblies can be used to allow the passage of a fluid from one conduit to another, to regulate, or to prevent such passage. The valve assembly is usually connected to the fluid conduits by means of conventional end connectors, the connection between the connectors and the valve assembly being tightened with compression nuts, in order to prevent leakage of fluid. For instance, the end connectors of the fluid conduits are provided with generally radially outwardly extending flanges cooperating with radially inwardly extending flanges disposed on the compression nuts, and the compression nuts are provided with an internal threading cooperating with an external threading of the body of the valve assembly. An example of such a valve assembly is presented in US2017/0138504 A1.

In industrial and chemical manufacturing processes, valves are often subjected to constant vibrations over long periods, causing the screw threads on the valve compression fittings to loosen or “wind off.” This leads to potential chemical leaks, safety hazards, environmental risks, and downtime for repairs. While vibration can be reduced and thread tightness checked, both are operationally difficult and can encompass hundreds of valves for a single installation.

U.S. Pat. No. 11,428,351B2, EP0704652A1, KR101231873B1, CN118188924A and KR102135898B1 offer different solutions to this problem with devices acting for in each of these solutions on one side of the valve assembly, i.e. on one compression nut. Consequently, these solutions are not efficient when used for both sides of the valve assembly.

KR101458370B1, KR200449225Y1, KR101314494B1, KR101773742B2 and KR102435284B1 propose locking systems that are each designed specifically for one type of valve. These systems are not compatible with other types of valves.

KR200471300Y1 and KR20180003123U offer solutions that are compatible with different types of valves, and allow the locking of the compression nuts located on both ends of the valves. However, for both solutions, the manufacturing process is complicated, and the mounting method is complex.

### SUMMARY

The present invention aims at solving these disadvantages by proposing a claw for securely immobilizing two compression nuts of a valve assembly, said valve assembly comprising:
two compression nuts, one at each of its ends, said compression nuts each comprising a male spline located on an outer surface, and
a stem and a bonnet, said bonnet comprising a plate extending in a plane substantially perpendicular to the stem,
   said claw comprising:
a first part and a second part, and
releasable fastening means for securing said first part to said second part, said first part and said second part each comprising an inner surface comprising a female spline adapted to match the male spline of the outer surface of one of the compression nuts,
   said claw further comprising a through hole, configured so that when said first part and said second part are fastened to each other by said releasable fastening means, said through hole is configured to accommodate said plate of said bonnet.

Thanks to these provisions, the compression nuts are securely immobilized, and there is no need to routinely check that they are properly tightened, even when the fluid conduits connected to the valve assembly are subject to vibrations. This is achieved by a claw which is easy to manufacture, and very simple to use, whether for mounting the claw on a valve assembly, or dismounting the claw from a valve assembly. The only tool required for mounting and dismounting of the claw is for the releasable fastening means, which can be standard products such as bolts. The mounting and dismounting of the clam on the valve assembly take less than five minutes each.

Said first part and said second part may present a substantially cylindrical open section, which is an easy way to immobilize the compression nut while ensuring easy mounting and dismounting.

Said through hole may be formed by the union of a first opening on said first part, and a second opening on said second part, which is a simple and robust embodiment of the invention.

Said through hole may have a substantially rectangular shape.

Said releasable fastening means may be located on two opposite sides of said through hole.

Said releasable fastening means consist of two bolts, which is a simple and efficient embodiment of the invention.

Said first part and said second part each comprise an outer surface comprising one groove, said claw comprising two tie straps, each groove being configured to accommodate one of the two tie straps. When the claw is mounted on the valve assembly, the tie straps, when tightened around the grooves, ensure even pressure distribution around the compression nuts, which reduces the risks of leaks.

The present invention also relates to a valve unit comprising a valve assembly and the claw of the invention, said valve assembly comprising one compression nut at each of its ends, said compression nuts each comprising a male spline located on an outer surface, said valve assembly comprising a stem, and a bonnet, said bonnet comprising a plate extending in a plane substantially perpendicular to said stem, said compression nuts being immobilized by said claw.

Thanks to these provisions, the compression nuts are securely immobilized, and there is no need to routinely check that they are properly tightened, even when the fluid conduits connected to the valve assembly are subject to vibrations. This is achieved by a claw which is easy to manufacture, and very simple to use, whether for mounting the claw on a valve assembly, or dismounting the claw from a valve assembly. The only tool required for mounting and dismounting of the claw is for the releasable fastening means, which can be standard products such as bolts. The mounting and dismounting of the clam on the valve assembly take less than five minutes each.

The present invention also relates to a method for securely immobilizing two compression nuts of a valve assembly, utilizing the claw of the invention, comprising the following steps:
tightening two compression nuts, each compression nut being located at one end of said valve assembly,
if needed, rotating each compression nut until the male splines of the compression nuts are ready to be aligned with the female splines of the first part and the second part, with the position of the through hole of the claw matching the position of the plate of the bonnet of said valve assembly,
sliding the first part and the second part each around a compression nut, until said plate passes through the through hole, the male splines of the compression nuts engaging the female splines of the first part and the second part,
securing the first part and the second part to each other using the releasable fastening means.

Thanks to these provisions, the compression nuts are securely immobilized, and there is no need to routinely check that they are properly tightened, even when the fluid conduits connected to the valve assembly are subject to vibrations. This is achieved by a claw which is easy to manufacture, and very simple to use, whether for mounting the claw on a valve assembly, or dismounting the claw from a valve assembly. The only tool required for mounting and dismounting of the claw is for the releasable fastening means, which can be standard products such as bolts. The mounting and dismounting of the clam on the valve assembly take less than five minutes each.

The present invention also relates to a method for securely immobilizing two compression nuts of a valve assembly, utilizing the claw of the invention, comprising the following steps:
tightening two compression nuts, each compression nut being located at one end of said valve assembly,
if needed, rotating each compression nut until the male splines of the compression nuts are ready to be aligned with the female splines of the first part and the second part, with the position of the through hole of the claw matching the position of the plate of the bonnet of said valve assembly,
sliding the first part and the second part each around a compression nut, until said plate passes through the through hole, the male splines of the compression nuts engaging the female splines of the first part and the second part,
securing the first part and the second part to each other using the releasable fastening means,
wrapping and tightening a tie strap around each groove of the claw.

Thanks to these provisions, the tie straps ensure even pressure distribution around the compression nut, which reduces the risks of leak.

### DESCRIPTION OF THE DRAWINGS

FIG. 1 is a perspective front view of a claw according to a preferred embodiment of the invention, mounted on a valve assembly.

FIG. 2 is a front view of the claw and the valve assembly of FIG. 1.

FIG. 3 is a perspective view of a first part of the claw of FIG. 1.

FIG. 4 is a perspective view of a second part of the claw of FIG. 1, with a tie strap.

FIG. 5 is a front view of the claw of FIG. 1.

FIG. 6 is a top view of the claw of FIG. 1.

FIG. 7 is a side view of the first part of the claw of FIG. 1.

FIG. 8 is a perspective view of a valve assembly adapted to receive a claw according to the invention.

### DETAILED DESCRIPTION

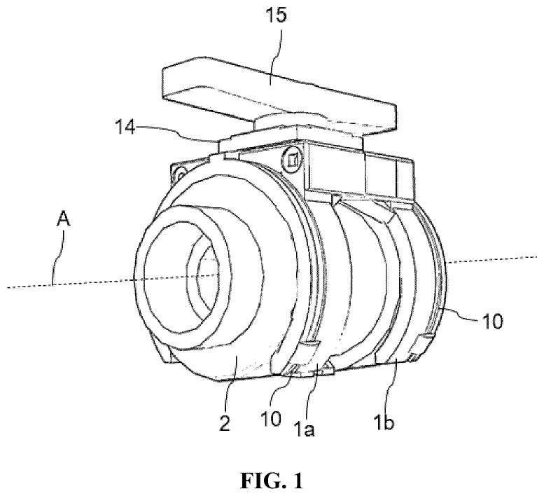

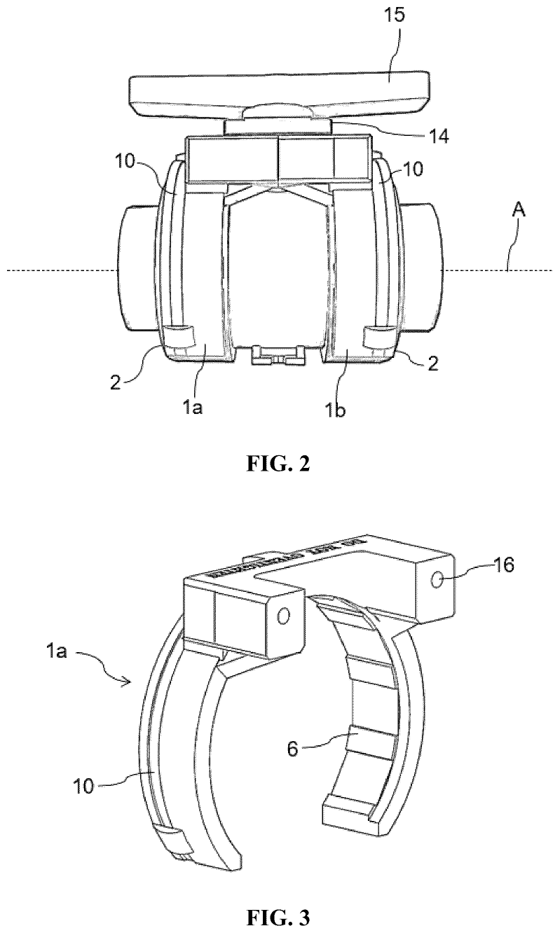

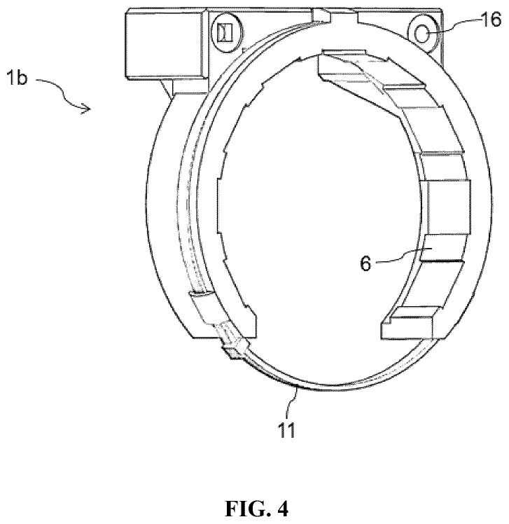

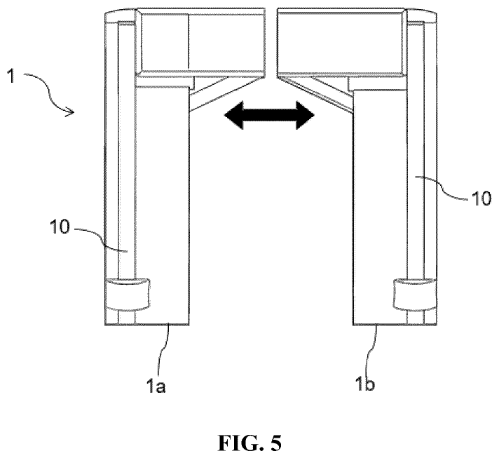

Referring to FIGS. 1 to 7, the claw 1 according to the invention is configured to securely immobilize two compression nuts 2 of a valve assembly. The valve assembly is connected to two fluid conduits at its extremities, the two fluid conduits being aligned and parallel to the main axis A of the valve assembly. In the present description, the ends of the valve assembly designate the ends relative to the main axis A of the valve assembly.

The valve assembly is for instance an industrial ball valve, comprising a hollow, perforated, and pivoting ball to control fluid flowing through it. The valve assembly may be a thermoplastic valve, such as a HAYWARD® ball valve. The valve assembly may correspond to the valve assembly described in US2017/0138504 A1.

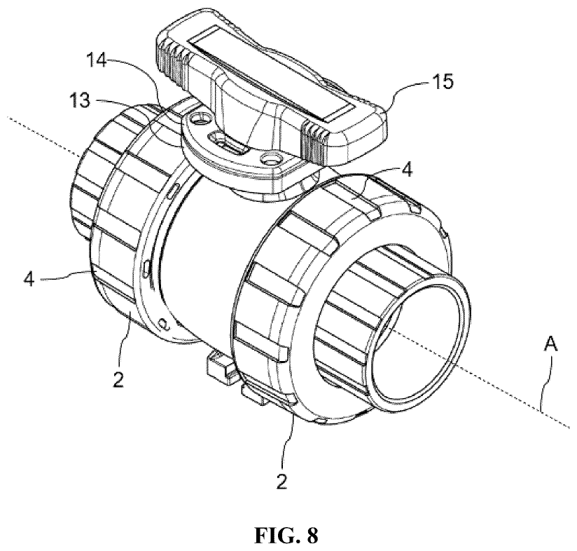

The valve assembly comprises two compression nuts 2, located at each end of the valve assembly. Each compression nut 2 allows the secure connection of the valve assembly to a fluid conduit, such as a pipe. The compression nuts 2 each comprise an outer surface comprising a male spline, and preferably, they comprise a threaded inner surface. For instance, the male spline of a compression nut 2 may have a generally cylindrical surface, interrupted by regularly distributed channels 4, the channels 4 being parallel to the axis of rotation of the compression nut 2, which is the main axis A, as can be seen on FIG. 8. Other types of male splines can be used with a claw 1 according to the invention.

The valve assembly also comprises a stem, and a bonnet. The bonnet is the component that covers the opening through which the stem passes, the stem being a slender rod or shaft that transmits motion from the actuator or handle to the valve internal mechanism, for example the ball, allowing it to open or close. The bonnet usually has a substantially cylindrical shape, extending in a direction perpendicular to the main axis A of the valve assembly. The bonnet comprises a plate 13, extending in a plane substantially perpendicular to the stem. The plate 13 may be configured to support a base 14 of an actuator 15 or handle of the valve assembly.

The claw 1 comprises a first part 1a and a second part 1b, the first part 1a and the second part 1b being preferably identical. The first part 1a and the second part 1b are each configured to partially surround one of the compression nuts 2, which means that each part 1a, 1b comprise an inner surface having a substantially cylindrical shape, the cylinder being opened on one side. In other words, the section of the inner surface is substantially an arc of a circle with an angle greater than 180°, for example comprised between 250 and 320 degrees, preferably between 275 and 295 degrees.

The first part 1a and second part 1b are preferably each a one-piece element, which means that they are each made from a single piece of material, without elements that may be separated from each other during normal use. The first part 1a and second part 1b may be made of a thermoplastic such as PTFE. They may be fabricated by any known method such as injection molding, vacuum casting, extrusion, CNC (Computer Numerical Control) machining, 3D printing, etc.

The material of the first part 1a and second part 1b may be chosen so that they present a certain elasticity, allowing the radius of its substantially cylindrical open section to increase. This way, the open part of the section of the first part 1a and second part 1b can be widened, to facilitate mounting of the claw 1 and dismounting of the claw 1 on the valve assembly.

The inner surface of each of the first part 1a and second part 1b comprise a female spline adapted to match the male spline of the outer surface of one of the compression nuts 2. For instance, if the male spline has a generally cylindrical surface, interrupted by regularly distributed channels 4, the female spline will have a generally cylindrical surface, interrupted by regularly distributed tongues 6, the channels 4 being adapted to accommodate the tongues 6. The female splines do not cover the entirety of the male splines, which extend over 360°. Preferably, the female splines cover the entire inner surface of the first part 1a and second part 1b.

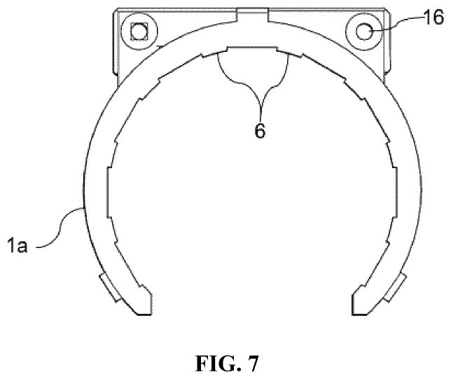

For instance, as illustrated on FIGS. 7 and 8, the male splines each comprise 12 evenly distributed channels 4, and the female splines each comprise 9 to 11 tongues 6, for example 10 tongues.

The first part 1a and the second part 1b may be secured to each other by releasable fastening means 15. For example, the first part 1a and second part 1b may each comprise at least two holes 16 with inner threads, configured to cooperate with bolts.

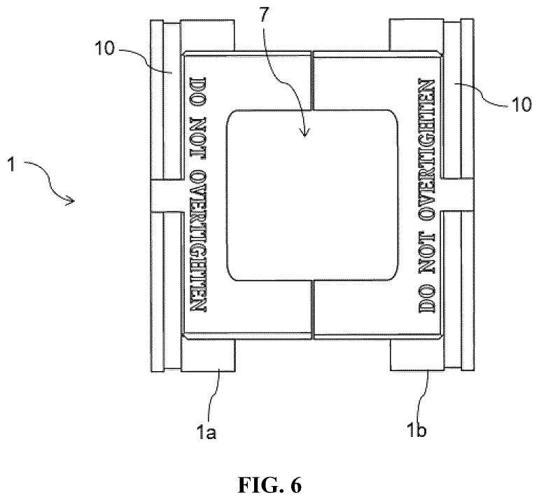

When the first part 1a and the second part 1b are secured together, the claw 1 comprises a through hole 7 configured to accommodate the plate 13. For example, as illustrated on FIG. 6, the plate 13 has a rectangular shape, and the through hole 7 has a rectangular shape, just adapted to fit the plate 13.

In a preferred embodiment, the first part 1a and second part 1b each comprise an opening, and when they are fastened together, the openings unite to form the through hole 7.

The fastening means may be located on two opposite sides of the through hole 7. That way, the assembled claw 1 presents a good mechanical resistance, while optimizing the quantity of material consumed to make the claw 1.

The through hole 7 is preferably located on the other side of the claw 1 relatively to the opening of the open sections of the first part 1a and the second part 1b, in order to reduce its impact on the mechanic resistance of the claw 1.

The first part 1a and the second part 1b may each comprise a groove 10. The grooves 10 are adapted to accommodate tie straps 11. Once the first part 1a and second part 1b are fastened to each other and the claw 1 is mounted on the valve assembly, the tie straps 11 may be tightened, to ensure a uniform repartition of the pressure of the claw 1 over the circumference of the compression nuts 2. The tie straps 11 may be made of stainless steel, or any other material offering the required elasticity and mechanical resistance, such as a plastic, for example nylon or polyamide.

The claw 1 may be used in a method for securely immobilizing two compression nuts 2 of a valve assembly, comprising the following steps:
tightening two compression nuts 2, each compression nut 2 being located at one end of the valve assembly. The tightening may be performed manually, or with a tool,
if needed, rotating each compression nut 2 until the male splines of the compression nuts 2 are ready to be aligned with the female splines of the first part 1a and the second part 1b, with the position of the through hole 7 of the claw 1 matching the position of the plate 13. It is important to make sure that this step does not result in untightening one of the compression nuts 2 until it is less tight than required during operation of the valve assembly,
sliding the first part 1a and the second part 1b each around a compression nut 2, until said plate 13 passes through the through hole 7, the male splines of the compression nuts 2 engaging the female splines of the first part 1a and the second part 1b,
securing the first part and the second part to each other, using the releasable fastening means,
if the claw 1 comprises grooves 10 and tie straps 11, as described above, wrapping and tightening a tie strap 11 around each groove 10 of the claw 1.

Once the claw 1 is mounted on the valve assembly, and the first part 1a and second part 1b are secured to each other, the compression nuts 2 are securely immobilized. Because of the matching between male splines and female splines, the compression nuts 2 cannot rotate relative to the first part 1a, respectively to the second part 1b. Because the first part 1a and second part 1b are secured to each other, the female spline of the first part 1a cannot rotate without the rotation of the female spline of the second part 1b. Finally, the compression nuts 2 being mounted in a symmetrical manner relatively to the center of the valve assembly, the direction of rotation to untighten one compression nut 2 corresponds to the direction of rotation to tighten the other compression nut 2. So once the claw 1 mounted on the valve assembly, if a first compression nut 2 tends to untighten, the same movement will tend to tighten the second compression nut 2, the tightening of the second compression nut 2 offering a resistance to the untightening of the first compression nut 2, and ultimately preventing the first compression nut 2 to reach an unsafe level of tightening.

1-6. (canceled)

7. A claw for securely immobilizing two compression nuts of a valve assembly, said valve assembly comprising:
one compression nut at each of its ends, said compression nuts each comprising a male spline located on an outer surface, and
a stem and a bonnet, said bonnet comprising a plate extending in a plane substantially perpendicular to the stem,
said claw comprising:
a first part and a second part, and
releasable fastening means for securing said first part to said second part,
said first part and said second part each comprising an inner surface comprising a female spline adapted to match the male spline of the outer surface of one of the compression nuts, said claw further comprising a through hole, configured so that when said first part and said second part are fastened to each other by said releasable fastening means, said through hole is configured to accommodate said plate of said bonnet, wherein said first part and said second part each comprise an outer surface comprising one groove, said claw comprising two tie straps, each groove being configured to accommodate one of the two tie straps.

8. A valve unit having a valve assembly and a claw, said valve assembly comprising:
one compression nut at each of its ends, said compression nuts each comprising a male spline located on an outer surface, said valve assembly comprising a stem, and a bonnet, said bonnet comprising a plate extending in a plane substantially perpendicular to said stem, said compression nuts being immobilized by said claw,
said claw being configured for securely immobilizing two compression nuts of said valve assembly, said claw comprising:
a first part and a second part, and
releasable fastening means for securing said first part to said second part,
said first part and said second part each comprising an inner surface comprising a female spline adapted to match the male spline of the outer surface of one of the compression nuts,
said claw further comprising a through hole, configured so that when said first part and said second part are fastened to each other by said releasable fastening means, said through hole is configured to accommodate said plate of said bonnet.

9. A method for securely immobilizing two compression nuts of a valve assembly, utilizing the valve unit of claim 8, comprising the following steps:
tightening two compression nuts, each compression nut being located at one end of said valve assembly, and
if needed, rotating each compression nut until the male splines of the compression nuts are ready to be aligned with the female splines of the first part and the second part, with the position of the through hole of the claw matching the position of the plate of the bonnet of said valve assembly,
sliding the first part and the second part each around a compression nut, until said plate passes through the through hole, the male splines of the compression nuts engaging the female splines of the first part and the second part,
securing the first part and the second part to each other using the releasable fastening means.

10. A method for securely immobilizing two compression nuts of a valve assembly, utilizing the claw of claim 7, comprising the following steps:
tightening two compression nuts, each compression nut being located at one end of said valve assembly,
if needed, rotating each compression nut until the male splines of the compression nuts are ready to be aligned with the female splines of the first part and the second part, with the position of the through hole of the claw matching the position of the plate of the bonnet of said valve assembly,
sliding the first part and the second part each around a compression nut, until said plate passes through the through hole, the male splines of the compression nuts engaging the female splines of the first part and the second part,
securing the first part and the second part to each other using the releasable fastening means, and
wrapping and tightening a tie strap around each groove of the claw.

11. The claw of claim 7, wherein said through hole is being formed by the union of a first opening on said first part, and a second opening on said second part.

12. The claw of claim 7, wherein said first part and said second part present a substantially cylindrical open section.

13. The claw of claim 7, wherein said through hole has a substantially rectangular shape.

14. The claw of claim 7, wherein said releasable fastening means are located on two opposite sides of said through hole.

15. The claw of claim 7, wherein said releasable fastening means includes two bolts.
